(19) United States
(12) Patent Application Publication
(10) Pub. No.: US 2006/0225956 A1
(43) Pub. Date: Oct. 12, 2006

(54) Easy-up-ladder

(76) Inventor: Dewey T. Myles JR., Arcadia, LA (US)

Correspondence Address: Dewey T. Myles, Jr., 1250 Davidson Road, Arcadia, LA, 71001, US

(21) Appl. No.: 11/093,659

(22) Filed: Mar. 31, 2005

(51) Int. Cl. E06C 7/16

(52) U.S. Cl. 182/116

(57) ABSTRACT

The nature of the Easy-Up-Ladder is to enhance the safety of the existing tree climbing stands. It is made to be able to climb up or climb down the ladder without having to jump. I thought of this idea because I personally hunt and had to jump up or jump down from my tree climbing stand. I designed this for myself and was told that there was a market for this invention.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR COMPUTER PROGRAM LISTING COMPACT DISC APPENDIX

Not Applicable

### BACKGROUND OF THE INVENTION

The reason for this invention is an added safety accessory to the existing tree climbing stands.

The climbing up and climbing down of this invention will allow the person not to have to jump on or off the tree climbing stand.

This invention can also be used for other hunters who use tree climbing stands while being ten to eighteen feet off of the ground.

A further reason of this invention is due to the different shapes of trees. As a hunter searches for an ideal tree in which to attach his tree climbing stand, the tree may be too large at the base, so he must attach it higher up.

The ladder is folded at the base of the tree climbing stand and can be unfolded.

### BRIEF SUMMARY OF THE INVENTION

The ladder will eliminate injury when climbing on the base of the tree climbing stand attached to the tree at a sharp acute angle. In this process of attaching the tree climbing stand up the tree two feet higher, the pressure of the base is forced down causing the base piece to bite into the tree giving the hunter a firm base to stand on as he climbs up or climbs down the tree.

The ladder is folded in the base of the tree climbing stand and can be unfolded. When unfolded, the person has a 26″ ladder on which he can climb up or climb down the ladder and not have to jump onto or jump down from the stand.

If a hunter finds a tree that is too large at the base, and becomes smaller two feet up, the hunter only has two choices. One choice is to attach the tree climbing stand at the bottom of the tree at a sharp angle. The second choice is to attach the tree climbing stand higher up the tree making a level platform.

The invention is attached to the base of the tree climbing stand by a bracket.

### BRIEF DESCRIPTION OF THE SEVERAL VIEWS OF THE DRAWING

FIG. 1 includes a sideview and on overhead view of the ladder.

FIG. 2 includes an sideview and an overhead view of the attachment bracket to the ladder.

### DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not be interpreted as limiting, but rather as a basis for the claims as a representative basis for teaching one skilled in the art to employ the present invention in virtually any appropriately detailed system, structure or manner.

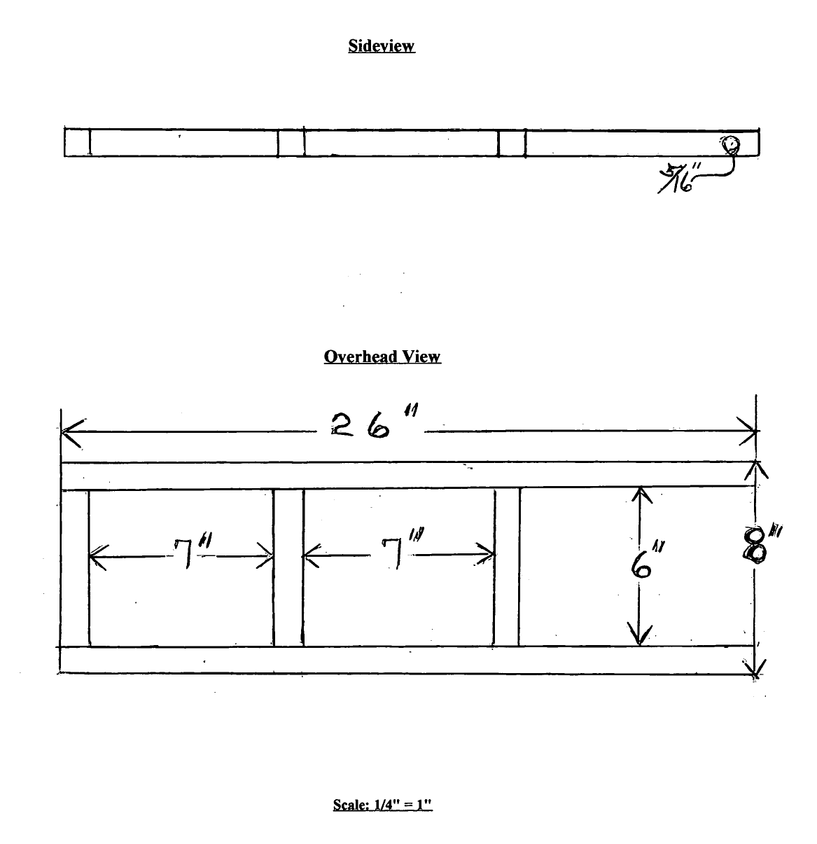

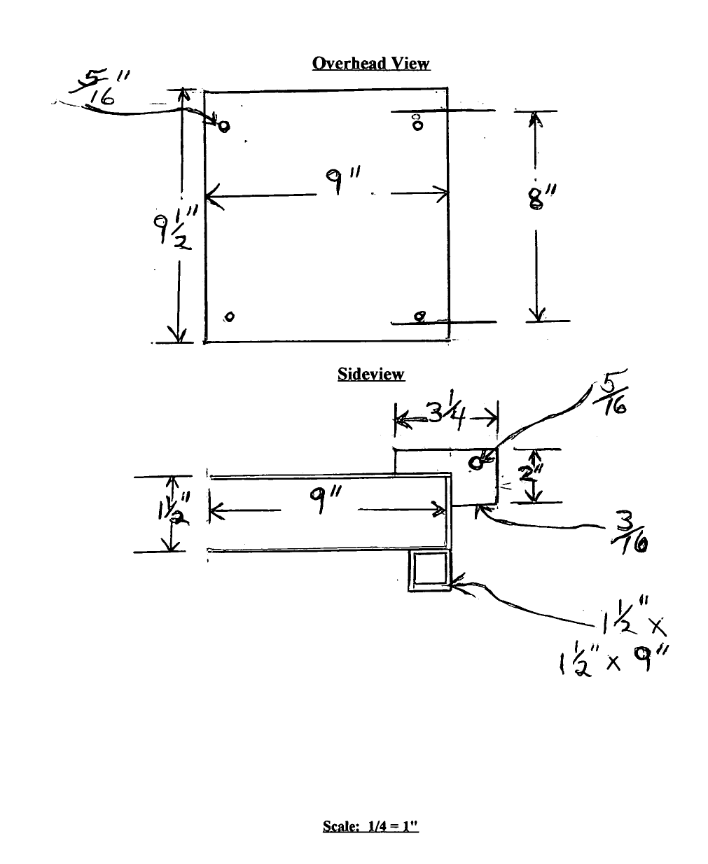

Referring now to FIG. 1, we first see a sideview of the ladder. At the top of the ladder, there is a 5/16″ hole on either side of the ladder. A ⅜″ bolt is inserted to attach the ladder to the attachment bracket in FIG. 2. The second item we see on FIG. 1 is an overhead view of the ladder. The overhead view shows the entire ladder 26″×8″. It is made up of 1″ square tube 6000 aluminum and ⅛″ 3003 aluminum.

It consists of two pieces 26″ long with three steps 6″ long welded 7″ apart from the bottom.

As shown in FIG. 2, the overhead view of the attachment bracket is 9″ long and 9½″ wide and sandwiches over the bottom of the tree climbing stand. This piece is made of ⅛″ 3003 aluminum. It attached by four bolts in such a manner so that the ladder does not pull the bracket under the bottom platform of the tree climbing stand or to the side of the bottom of the tree climbing stand. On top of the 9″ by 9½″ piece, two brackets are welded 8″ apart with a 5/16″ hole in each. These pieces are made of a 3/16″ aluminum plate. They are in the shape of and upside L, 2″ by 2″ (this is seen in the sideview of FIG. 2). The ladder is bolted between the two brackets that are 8″ apart. This makes it possible to lower the ladder and climb up on the base of the tree climbing stand or fold the ladder inside laying it on the tree climbing stand platform. The sideview consists of a 9″ by 9½″ sandwich piece made of ⅛″ 3003 aluminum. The metal has two bends with 1½″ with between them. Beneath the 9″ by 9½″ sandwich piece is a 1½″ by 1½″ aluminum tube that is welded so that the ladder will not fold under the base of the tree climbing stand.

The above descriptions and illustrations show how the Easy-Up-Ladder is a 26×8″ ladder that helps a hunter get on the base of a tree climbing stand. The ladder is built so that it can be attached as an accessory to different make of tree climbing stands.

1. I personally designed this Easy-Up Ladder to avoid injury when climbing up and climbing down the base of my tree climbing stand. After checking with magazines, and people working in the field of tree climbing manufactures, I was made aware that the Easy-Up Ladder would be a plus to safety in the use of the tree climbing stand. I searched the internet and found nothing like it. I was told by a person who produced tree climbing stands for 25 years, that my Easy-Up-Ladder was needed and that I should
